(19) United States
(12) Patent Application Publication
(10) Pub. No.: US 2025/0117846 A1
(43) Pub. Date: Apr. 10, 2025

(54) SYSTEM AND METHOD FOR DETERMINING OPTIMAL RESOURCE TRANSFER ROUTING USING QUANTUM GATEWAY OPTIMIZATION

(71) Applicant: BANK OF AMERICA CORPORATION, Charlotte, NC (US)

(72) Inventors: Subburathinam Krishnan, Chennai (IN); Amit Mishra, Egattur (IN); Shailendra Singh, Thane West (IN); Krithika Viswanathan, Moulivakkam (IN)

(73) Assignee: BANK OF AMERICA CORPORATION, Charlotte, NC (US)

(21) Appl. No.: 18/376,533

(22) Filed: Oct. 4, 2023

(51) Int. Cl. G06N 10/70; G06N 10/20

(52) U.S. Cl. CPC G06N 10/70; G06N 10/20

(57) ABSTRACT

Systems, computer program products, and methods are described herein for determining optimal resource transfer routing using quantum gateway optimization. The present disclosure is configured to receive a resource transfer request associated with transferring a resource from a submitting device to a receiving device, wherein the resource transfer request comprises resource transfer instructions and resource transfer metadata; determine, in response to the resource transfer request, an optimized gateway route, wherein the optimized gateway route defines a series of gateways that the resource to be transferred may be processed, and wherein determining the optimized gateway route comprises analyzing the resource transfer instructions, resource transfer metadata, and one or more gateway route characteristics; and complete the resource transfer request, wherein completing the resource transfer request, wherein completing the resource transfer request comprises transferring the resource from the submitting device to the receiving device via the optimized gateway route.

### TECHNOLOGICAL FIELD

Example embodiments of the present disclosure relate to determining optimal resource transfer routing using quantum gateway optimization.

### BACKGROUND

There are significant challenges associated with optimally orchestrating resource transactions through gateways. Applicant has identified a number of deficiencies and problems associated with determining optimal resource transfer routing using quantum gateway optimization. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for determining optimal resource transfer routing using quantum gateway optimization.

Embodiments of the present invention address the above needs and/or achieve other advantages by providing apparatuses (e.g., a system, computer program product, and/or other devices) and methods for determining optimal resource transfer routing using quantum gateway optimization. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention receives a resource transfer request associated with transferring a resource from a submitting device to a receiving device, wherein the resource transfer request comprises resource transfer instructions and resource transfer metadata. In some embodiments, the present invention determines, in response to the resource transfer request, an optimized gateway route, wherein the optimized gateway route defines a series of gateways that the resource to be transferred may be processed, and wherein determining the optimized gateway route comprises analyzing the resource transfer instructions, resource transfer metadata, and one or more gateway route characteristics. In some embodiments, the present invention completes the resource transfer request, wherein completing the resource transfer request comprises transferring the resource from the submitting device to the receiving device via the optimized gateway route.

In some embodiments, the resource transfer metadata includes security characteristics, wherein the security characteristics include a securitization value associated with the resource transfer request. In some embodiments, the resource transfer metadata includes priority characteristics, wherein the priority characteristics comprise a prioritization value associated with the resource transfer request. In some embodiments, the resource transfer metadata includes expense characteristics, wherein the expense characteristics comprise an expense value associated with the resource transfer request.

In some embodiments, determining the optimized gateway route includes determining, in real time and in response to the resource transfer metadata, the optimized gateway route which provides the highest securitization value. In some embodiments, determining the optimized gateway route includes determining, in real time and in response to the resource transfer metadata, the optimized gateway route which provides the highest prioritization value. In some embodiments, determining the optimized gateway route includes determining, in real time and in response to the resource transfer metadata, the optimized gateway route which provides the least expense value.

In some embodiments, determining the optimized gateway route includes caching, in response to receiving the resource transfer request, the resource transfer request into a resource caching module. In some embodiments, determining the optimized gateway route includes processing the resource transfer request in a quantum elastic resource gateway.

In some embodiments, the quantum elastic resource gateway includes a quantum route optimization algorithm, wherein the quantum route optimization algorithm comprises an intra gateway resource transfer request. In some embodiments, the quantum elastic resource gateway includes a quantum node optimization algorithm, wherein the quantum node optimization algorithm comprises an inter gateway resource transfer request. In some embodiments, the quantum elastic resource gateway includes a prioritized routing module, wherein the prioritized routing module routes the resource through the one or more gateways based on the resource transfer metadata. In some embodiments, the quantum elastic resource gateway includes a recommendations module, wherein the recommendations module comprises determining the optimized gateway route based on the resource transfer metadata. In some embodiments, the quantum elastic resource gateway includes a quantum error correction module.

In some embodiments, the present invention transfers the resource via the prioritized routing module, wherein the prioritized routing module determines the optimized gateway route in response to the prioritization value. In some embodiments, the present invention transfers the resource via the recommendations module, wherein the recommendations module determines the optimized gateway route in response to one or more previously recommended optimized gateway routes.

In some embodiments, the quantum node optimization algorithm includes the one or more quantum route optimization algorithms, wherein the quantum node optimization algorithm connects the one or more quantum route optimization algorithms.

In some embodiments, the quantum error correction module includes determining, in response to the resource transfer request failing to complete, the resource should be transferred to the submitting device. In some embodiments, the quantum error correction module includes transferring the resource to the submitting device through the one or more gateways.

In some embodiments, determining the optimized gateway route includes determining an unoptimized gateway route, wherein the unoptimized gateway route comprises determining the transfer of the resource without optimizing the gateway route. In some embodiments, determining the optimized gateway route includes determining an unoptimized number of resources, wherein the unoptimized number of resources is associated with an unoptimized gateway route. In some embodiments, determining the optimized gateway route includes determining the optimized gateway route. In some embodiments, determining the optimized gateway route includes determining an optimized number of resources, wherein the optimized number of resources is associated with the optimized gateway route. In some embodiments, determining the optimized gateway route includes ensuring the optimized number of resources is equal to or less than the unoptimized number of resources.

In some embodiments, the gateway route characteristics include an existing volume, wherein the existing volume is associated with a volume of traffic a network is currently experiencing, wherein the network comprises one or more gateway routes. In some embodiments, the gateway route characteristics include an existing latency, wherein the existing latency is associated with a latency the network is currently experiencing. In some embodiments, the gateway route characteristics include a gateway security, wherein the gateway security is associated with a gateway security value of the one or more gateways. In some embodiments, the gateway route characteristics include a gateway expense, wherein the gateway expense is associated with a gateway expense value of the one or more gateways.

In some embodiments, determining the optimized gateway route includes ensuring the gateway security value is equal to or greater than the security value associated with the resources transfer request. In some embodiments, determining the optimized gateway route includes ensuring the gateway expense value is equal to or less than the expense value associated with the resource transfer request.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining optimal resource transfer routing using quantum gateway optimization, in accordance with an embodiment of the disclosure;

FIG. 2 illustrates a process flow for determining optimal resource transfer routing using quantum gateway optimization, in accordance with an embodiment of the disclosure.

FIG. 3 illustrates a process flow for processing a resource transfer request in a quantum elastic resource gateway, in accordance with an embodiment of the disclosure.

FIG. 4 illustrates a non-limiting example process flow of a quantum route optimization algorithm, in accordance with an embodiment of the disclosure.

FIG. 5 illustrates a non-limiting example process flow of the optimal resource transfer system, in accordance with an embodiment of the disclosure.

FIG. 6 illustrates a non-limiting example process flow of a quantum node optimization algorithm, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “transfer,” a “distribution,” and/or an “allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

With the recent increase in the resource transaction landscape, there are multiple resource transaction providers who cater to a variety of resource transactions. The different providers and resource transaction types offer an ever-growing user base more options for resource transactions than ever before. Due to this, entire resource transaction system experience degradation in performance, specifically relating to the speed at which transactions are completed. Further, there exists security implications for users of the system and the system itself. Currently, there is no solution which can identify the most optimal orchestration of a resource transaction through resource transaction gateways and channels in real time with the minimal latency in combination with ensuring secure execution of the resource transactions.

In some embodiments, the present disclosure provides a system that may receive a payment request from a user. In some embodiments, the payment request may include a variety of characteristics (e.g., settings set by the user) which describe how the payment should be treated in the system. In some embodiments, the characteristics may include a priority setting, a security setting, an expense setting, and/or the like. In some embodiments, the system may determine the best payment route in response to considering the payment characteristics. In some embodiment, the system may also consider other characteristics to determine the best payment route, such as known characteristics of the route, historical route options, and/or the like. In this way, the system may determine the best route with the information provided to the system. In some embodiments, the system may use quantum computing to determine the best route to ensure a fast, secure, and low cost route. In some embodiments, the system may use a prioritized routing module, quantum recommendation as a service, a recommendations module, and/or the like to determine the best route. In some embodiments, if a payment needs to be returned to the sender (due to errors, or the like), the system may determine the best route in a similar manner (e.g., considering the characteristics of the route to determine a fast, secure, and low cost route).

What is more, the present disclosure provides a technical solution to a technical problem. As described herein, the technical problem includes issues relating to current resource transaction systems choosing suboptimal resource transaction channels, which may lead to high latency of the resource transactions and opportunity for misappropriations to occur. The technical solution presented herein allows for dynamic, secure, effective, and prioritized transfers of resource transfer requests. In particular, the optimal resource transfer system is an improvement over existing solutions to the issue of conventional resource transfer routing systems, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the optimal resource transfer system (e.g., system 130), as described herein, solves the problem of issues arising from convention resource transfer routing system. Specifically, conventional resource transfer routing systems suffer from lack of security, slow resource transfers, higher costs associated with the resource transfer, among other issues. Therefore, the improvement disclosed herein develops an optimal resource transfer system to specifically improve the functionality and capability of resource transfer systems. Further, the optimal resource transfer system may be characterized as identifying a specific improvement in computer capabilities and/or network functionalities in response to the optimal resource transfer system's integration to existing devices, software, applications, and/or the like. In this way, the optimal resource transfer system improves the capability of a system to determine optimal resource transfer routes. Further, the optimal resource misappropriation system improves the functionality of networks in response to reducing the resources consumed by the system (e.g., network resources, computing resources, memory resources, and/or the like).

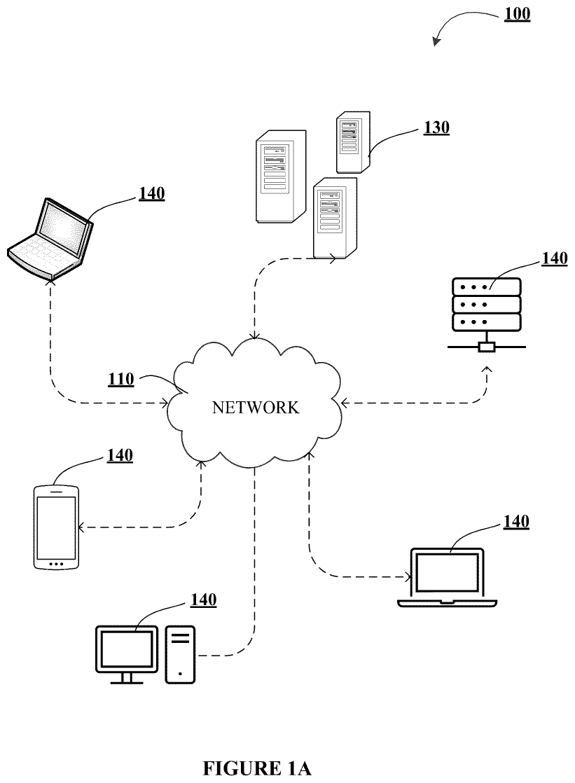

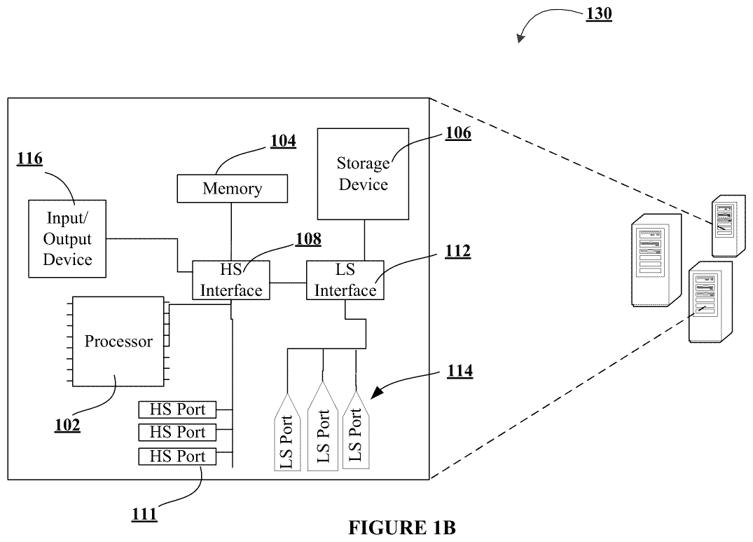

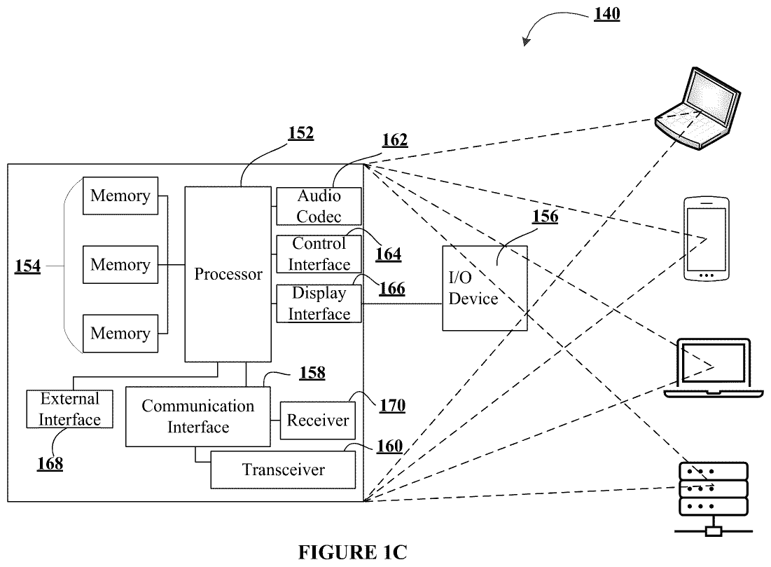

FIGS. 1A-1C illustrate technical components of an exemplary distributed computing environment 100 for determining optimal resource transfer routing using quantum gateway optimization, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

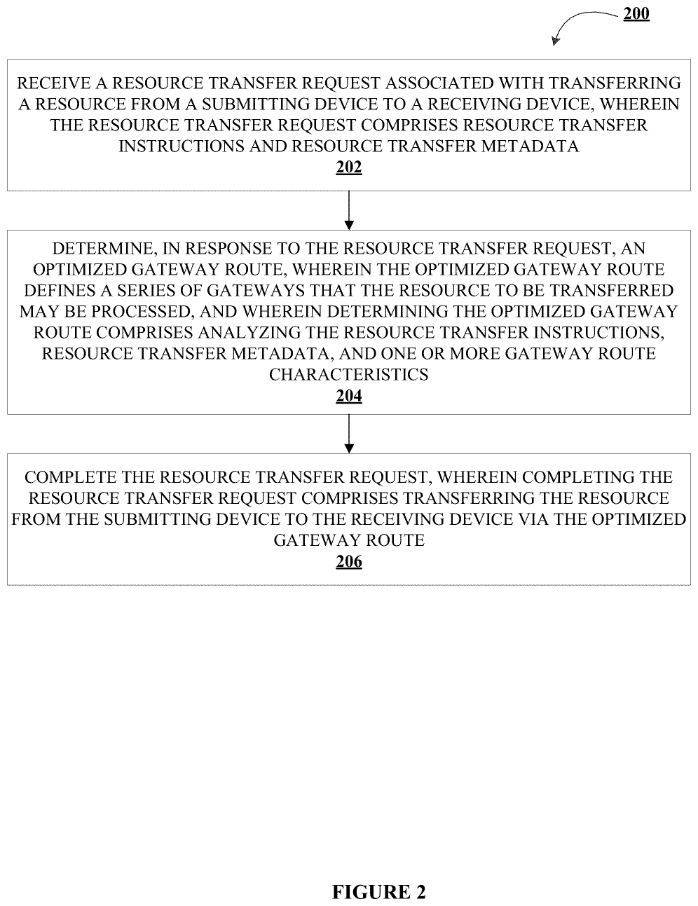

FIG. 2 illustrates a process flow for determining optimal resource transfer routing using quantum gateway optimization, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an optimal resource transfer system (e.g., similar to one or more of the systems described herein with respect to FIGS. 1A-1C) may perform one or more of the steps of process flow 200. For example, an optimal resource transfer system (e.g., the system 130 described herein with respect to FIGS. 1A-1C) may perform the steps of process flow 200.

As shown in block 202, the process flow 200 of this embodiment includes receiving a resource transfer request associated with transferring a resource from a submitting device to a receiving device, wherein the resource transfer request comprises resource transfer instructions and resource transfer metadata. In some embodiments, the resource transfer request may include a request intend, a request intend from payment proxy, and/or the like. In some embodiments, a request intend may include a purpose or intent for a particular transaction, such as a purchase, refund, transfer, withdrawal, and/or the like. In some embodiments, the request intend from payment proxy may include a requested intend on behalf of another person, which may include third-party services that handle payments for others.

In some embodiments, the submitting device may include a variety of devices, end-point devices (e.g., end-point device(s) 140), and/or the like, as listed above. In some embodiments, the receiving device may include a variety of devices, end-point devices (e.g., end-point device(s) 140), and/or the like, as listed above.

In some embodiments, the resource transfer instructions may include instructions from a user that tell the optimal resource transfer system how to handle the resource transfer. In some embodiments, the instructions may include a designated receiver of the resources, a timeframe the resource transfer must take place within (e.g., priority characteristics), an amount of resource to be transferred, an amount of expenses the user is willing to pay (e.g., expense characteristics), an expected security level (e.g., security characteristics), gateways the user wishes to avoid, and/or the like.

In some embodiments, the resource transfer metadata may include security characteristics, wherein the security characteristics include a securitization value associated with the resource transfer request. In some embodiments, the securitization value may include a user's preferences on the security of the resource transfer. In this way, the user may select the security of the user's resource transfer. For instance, and by way of non-limiting example, if the user wishes for the resource transfer to have a high security, the optimal resource transfer system may adjust the gateway route in the optimized gateway route to include gateways that offer security in the user's resource transfer. In some embodiments, the optimal resource transfer system may automatically adjust the securitization value in response to the user.

In some embodiments, the resource transfer metadata may include priority characteristics, wherein the priority characteristics comprise a prioritization value associated with the resource transfer request. In some embodiments, the prioritization value may include a user's preferences on the priority of the resource transfer. In this way, the user may select the priority of the user's resource transfer. For instance, and by way of non-limiting example, if the user wishes for the resource transfer to have a high priority, the optimal resource transfer system may adjust the gateway route in the optimized gateway route to include gateways that prioritize the user's resource transfer. In some embodiments, the optimal resource transfer system may automatically adjust the prioritization value in response to the user.

In some embodiments, the resource transfer metadata may include expense characteristics, wherein the expense characteristics comprise an expense value associated with the resource transfer request. In some embodiments, the expense value may include a user's preferences on the security of the resource transfer. In this way, the user may select the expense of the user's resource transfer. For instance, and by way of non-limiting example, if the user wishes for the resource transfer to have a low expense, the optimal resource transfer system may adjust the gateway route in the optimized gateway route to include gateways that offer low expense for the user's resource transfer. In some embodiments, the optimal resource transfer system may automatically adjust the expense value in response to the user.

In some embodiments, the resource transfer metadata may include metadata of the resource transaction. In some embodiments, the resource transfer metadata may include a source region, a destination region, a sender, a receiver, an amount, a timestamp, and/or the like. In some embodiments, the optimal resource transfer system may determine that, in response to the metadata of the resource transaction, the optimized gateway route should or should not include certain gateways. For instance, and by way of non-limiting example, if a certain resource transfer contains metadata to avoid a certain country (e.g., due to sanctions, restrictions, regulations, and/or the like), the optimal resource transfer system may route the resource transfer around that country. In this way, the optimal resource transfer system may continually analyze the metadata of a resource transaction to determine the optimized gateway route.

As shown in block 204, the process flow 200 of this embodiment includes determining, in response to the resource transfer request, an optimized gateway route, wherein the optimized gateway route defines a series of gateways that the resource to be transferred may be processed, and wherein determining the optimized gateway route comprises analyzing the resource transfer instructions, resource transfer metadata, and one or more gateway route characteristics.

In some embodiments, the series of gateways may include a set of gateways the resource may potentially be transferred through. In this way, the series of gateways may include resource processing points along the way of the resource transfer. In some embodiments, the series of gateways may be associated with the user, a merchant the user is transacting with, an entity the user is associated with, and/or the like. In some embodiments, the series of gateways may not be directly associated with the user but may be associated with the merchant or entity the user is associated with. In some embodiments, the series of gateways may include layers (e.g., layers of gateways) between the merchant the user is associated with and a resource transaction processor the user is associated with. For instance, and by way of non-limiting example, the series of gateways may include a presentation gateway, an application gateway, a processing gateway, a data gateway, a switching gateway, a certification gateway, a partner API gateway, a monitoring gateway, a hardware gateway, and/or the like.

In some embodiments, determining the optimized gateway route may include determining an unoptimized gateway route, wherein the unoptimized gateway route comprises determining the transfer of the resource without optimizing the gateway route. In this way, the unoptimized gateway route may include a route that has not be determined by the optimal resource transfer system (e.g., system 130).

In some embodiments, determining the optimized gateway route may include determining an unoptimized number of resources, wherein the unoptimized number of resources is associated with an unoptimized gateway route. In some embodiments, the unoptimized number of resources may include the resources (e.g., computing resources, networking resources, memory resources, storage resources, and/or the like) the unoptimized gateway route consumes during transfer.

In some embodiments, determining the optimized gateway route (e.g., determined using the optimal resource transfer system) may include determining an optimized number of resources, wherein the optimized number of resources is associated with the optimized gateway route. In some embodiments, the optimized number of resources may include the resources (e.g., computing resources, networking resources, memory resources, storage resources, and/or the like) the optimized gateway route consumes during transfer.

In some embodiments, determining the optimized gateway route may include ensuring the optimized number of resources is equal to or less than the unoptimized number of resources. In this way, the optimal resource transfer system may determine a gateway route (e.g., the optimized gateway route) that consumes an equal or lesser amount of resources (e.g., computing resources, networking resources, memory resources, storage resources, and/or the like) than the unoptimized gateway route (e.g., the route determined without using the optimal resource transfer system).

In some embodiments, the gateway route characteristics may include an existing volume, wherein the existing volume is associated with a volume of traffic a network is currently experiencing, wherein the network comprises one or more gateway routes.

In some embodiments, the gateway route characteristics may include an existing latency, wherein the existing latency is associated with a latency the network is currently experiencing. In some embodiments, the gateway route characteristics may include a gateway security, wherein the gateway security is associated with a gateway security value of the one or more gateways. In some embodiments, the gateway security value may include a known value from a trusted third party entity. In some embodiments, the gateway security value may include a security valued determined by the entity associated with the optimal resource transfer system. In this way, the gateway security value may provide information relating to the security of the gateway through which the resource transfers. For instance, and by way of non-limiting example, if a particular gateway is hosted from a sanctioned country, that gateway may have a low gateway security value.

In some embodiments, the gateway route characteristics may include a gateway expense, wherein the gateway expense is associated with a gateway expense value of the one or more gateways. In some embodiments, the gateway expense value may include the transaction costs associated with using the gateway. For instance, and by way of non-limiting example, a gateway that has a high cost associated with using the gateway may have a high gateway expense value.

In some embodiments, determining the optimized gateway route may include ensuring the gateway security value is equal to or greater than the security value associated with the resources transfer request. In some embodiments, the security value of the resource transfer request may originate from the user at the time of the user making the transaction. In this way, the user may select a security value, or a range of security values, the user wishes. For instance, and by way of non-limiting example, if the user wishes to have a highly secure payment transaction, the user may select a high security value on the resource transfer request. Further, the optimal resource transfer system may choose the optimized gateway route to include gateways that have at least as high of a security value the user requested. In other words, the optimal resource transfer system may compare the security value of the resource transfer request with the gateway security value of each gateway to determine a gateway route (e.g., optimized gateway route) that meets the user's security requirements.

In some embodiments, determining the optimized gateway route may include ensuring the gateway expense value is equal to or less than the expense value associated with the resource transfer request. In some embodiments, the expense value of the resource transfer request may originate from the user at the time of the user making the transaction. In this way, the user may select an expense value, or range of expense values, the user wishes. For instance, and by way of non-limiting example, if the user wishes to have a low expense payment transaction, the user may select a low expense value on the resource transfer request. Further, the optimal resource transfer system may choose the optimized gateway route to include gateways that have lower costs associated with the gateways. In other words, optimal resource transfer system may compare the expense value of the resource transfer request with the gateway expense value of each gateway to determine a gateway route (e.g., optimized gateway route) that meets the user's expense requirements.

In some embodiments, the data associated with a resource transfer may be supplemented by additional data obtained from an interaction between the user device (e.g., end-point device(s) 140, or the like) and the optimal resource transfer system 130. For example, in some embodiments, the system may determine, based on location data obtained from a position system of a user device (e.g., end-point device 140) that a user is in closer proximity to a first gateway than a second gateway. In some embodiments, the optimal resource transfer system may weight that information accordingly to determine that the resource transfer may is more likely to have priority at the first gateway than the second gateway. Additionally, or alternatively, the optimal resource transfer system may determine, based on information (e.g., metadata, or the like) obtained from a user device that the user is interested in or intending to interact with a particular merchant. As with location-based data, the optimal resource transfer system may weight the information to determine that the resource transfer is more like to occur with the particular merchant if the user has indicated interest in that particular merchant.

In some embodiments, the optimal resource transfer system may weight and consider any and all information received from devices interacting with the optimal resource transfer system. For instance, and by way of non-limiting example, the optimal resource transfer system may include the resource transfer metadata when determining the optimized gateway route. In this way, the optimal resource transfer system may weight the security characteristics, priority characteristics, expense characteristics, and/or the like in different ways for each determination of an optimized gateway route. For example, in some embodiments, the optimal resource transfer system may determine that, in a particular resource transfer, the priority characteristics should be weighted more heavily than the other factors. The optimal resource transfer system may then adjust the weight values while still considering the security and expense requirements of the resource transfer. In this example, the resource transfer may include a high priority value and a high security value, but may also have a high expense value, which may lead to more costs (e.g., high expense) associated with transferring the resource in a timely (e.g., high priority) and secure (e.g., high security) manner.

In some embodiments, the optimal resource transfer system may weight the factors in different ways in response to receiving external information. In this way, the optimal resource transfer system may receive information relating to a country's laws, rules, regulations, trade restrictions, and/or the like. For instance, and by way of non-limiting example, if a particular country has rules and regulations requiring additional expense on all capital transferred in and out of the country, the optimal resource transfer system may weight that information into the expense characteristics and the priority characteristics when determining the optimized gateway route. In this way, the optimal resource transfer system may consider alternate gateway routes around the country in question and determine whether the alternate routes may transfer the resource in a comparable way. Further, within that consideration, the optimal resource transfer system may weight the security, expense, and priority values to determine the optimized gateway route.

As shown in block 206, the process flow 200 of this embodiment includes completing the resource transfer request, wherein completing the resource transfer request comprises transferring the resource from the submitting device to the receiving device via the optimized gateway route. In some embodiments, completing the optimal resource transfer system may notify the user of the completed transfer of the resource. In some embodiments, the optimal resource transfer system may configure a graphical user interface on the user device with the notification of completion.

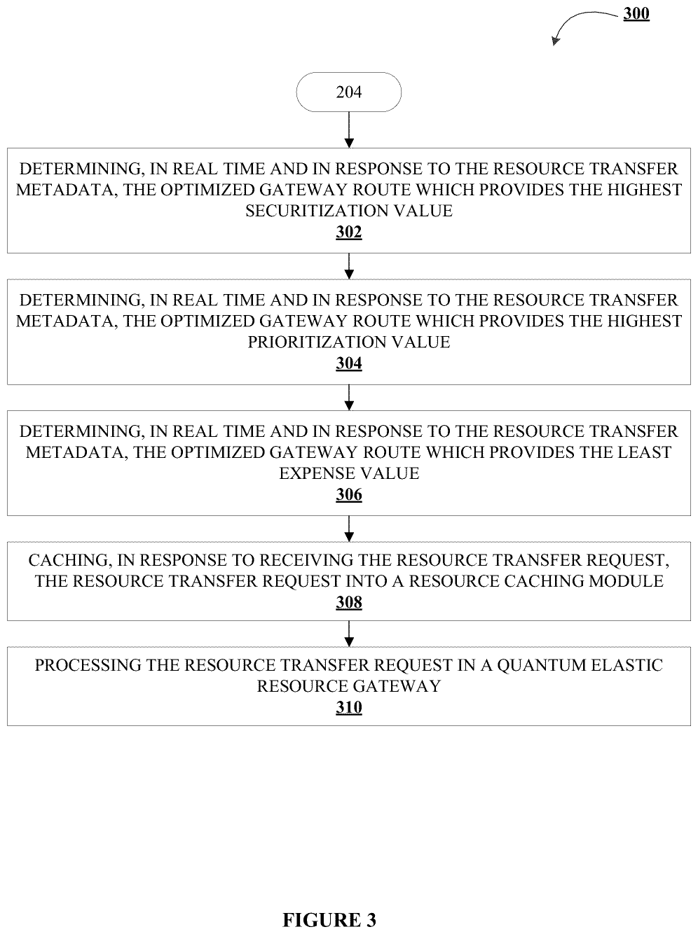

FIG. 3 illustrates a process flow for processing a resource transfer request in a quantum elastic resource gateway, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an optimal resource transfer system (e.g., similar to one or more of the systems described herein with respect to FIGS. 1A-1C) may perform one or more of the steps of process flow 300. For example, an optimal resource transfer system (e.g., the system 130 described herein with respect to FIGS. 1A-1C) may perform the steps of process flow 300.

As shown in block 302, the process flow 300 of this embodiment includes determining, in real time and in response to the resource transfer metadata, the optimized gateway route which provides the highest securitization value. In some embodiments, the securitization value may include the security value of the resource transfer request, the gateway security value, and/or the like. In this way, the securitization value may aggregate the security value and the gateway security value to determine the optimized gateway route. For instance, the optimized gateway route may include a gateway route that has the highest securitization value throughout the gateway route.

In some embodiments, determining the optimized gateway route which provides the highest securitization value may include a real time calculation of the potential gateways to ensure the highest securitization value. In some embodiments, the optimal resource transfer system may determine the highest securitization value of the gateway route by calculating the securitization values of the gateways in real time. In this way, the optimized gateway route may have the most up to date information regarding the securitization value. In some embodiments, the optimal resource transfer system may be able to determine an optimized gateway route with a high securitization value in response to the traffic flowing through the series of gateways. In this way, the optimal resource transfer system may adjust the optimized gateway route in response to the available gateways (e.g., gateways available in the series of gateways).

As shown in block 304, the process flow 300 of this embodiment includes determining, in real time and in response to the resource transfer metadata, the optimized gateway route which provides the highest prioritization value. In some embodiments, the optimal resource transfer system may determine the prioritization value of the optimized gateway route by analyzing the prioritization value of the entire optimized gateway route. In some embodiments, the optimal resource transfer system may weight the prioritization value of one or more gateway routes in order to compare the gateway routes.

In some embodiments, determining the prioritization value of the gateway routes may include analyzing the gateways that make up the optimized gateway route. In this way, the optimized gateway route (e.g., with a high prioritization value) may include gateways that treat the resource transfer with a high priority. For instance, and by way of non-limiting example, the gateway that includes a high priority may include a gateway that transfers the resource sooner than other unrelated resource transfers. In some embodiments, the optimal resource transfer system may determine the optimized gateway route by analyzing rules, regulations, relationships, interface compatibility, software applications, hardware equipment, stability, and/or the like of the gateway. In this way, the optimal resource transfer system may learn the capabilities of a gateway and compare the capabilities with a resource transfer request. Further, in some embodiments, the optimal resource transfer system may choose an optimized gateway route that ensures the resource transfer has the highest prioritization value available within the series of potential gateways.

As shown in block 306, the process flow 300 of this embodiment includes determining, in real time and in response to the resource transfer metadata, the optimized gateway route which provides the least expense value. In some embodiments, the optimal resource transfer system may determine the expense value of the optimized gateway route by analyzing the expense value of the entire optimized gateway route. In some embodiments, the optimal resource transfer system may weight the expense value of one or more gateway routes in order to compare the gateway routes.

In some embodiments, determining the expense value of the gateway routes may include analyzing the gateways that make up the optimized gateway route. In this way, the optimized gateway route (e.g., with the lowest expense value) may include gateways that have a low expense value associated with the gateway. For instance, and by way of non-limiting example, the gateway that includes a low expense may include a gateway that transfer the resource with a lower expense than other gateways. In some embodiments, the optimal resource transfer system may determine the optimized gateway route by analyzing rules, regulations, relationships, interface compatibility, software applications, hardware equipment, stability, and/or the like of the gateway. In this way, the optimal resource transfer system may learn the expense associated with a gateway and compare expense values of other gateways when determining the optimized gateway route. Further, in some embodiments, the optimal resource transfer system may choose an optimized gateway route that ensures the resource transfer has the lowest expense value available within the series of potential gateways.

As shown in block 308, the process flow 300 of this embodiment includes caching, in response to receiving the resource transfer request, the resource transfer request into a resource caching module. In some embodiments, the resource caching module may include a system (e.g., module) that stores the resource transfer request. In some embodiments, the storage of the resource transfer request may enable the optimal resource transfer module to more effectively transfer the resources in a faster, more secure, and lower expense manner. For instance, and by way of non-limiting example, the resource caching module may enable the optimal resource transfer system to hold the resource transfer in storage while the optimal resource transfer system analyzes the optimal resource route that is most capable of transferring the resources in the desired manner.

As shown in block 310, the process flow 300 of this embodiment includes processing the resource transfer request in a quantum elastic resource gateway. In some embodiments, the quantum elastic resource gateway includes a quantum route optimization algorithm, wherein the quantum route optimization algorithm comprises an intra gateway resource transfer request. In some embodiments, the quantum elastic resource gateway includes a quantum node optimization algorithm, wherein the quantum node optimization algorithm comprises an inter gateway resource transfer request. In some embodiments, the quantum elastic resource gateway includes a prioritized routing module, wherein the prioritized routing module routes the resource through the one or more gateways based on the resource transfer metadata. In some embodiments, the quantum elastic resource gateway includes a recommendations module, wherein the recommendations module comprises determining the optimized gateway route based on the resource transfer metadata. In some embodiments, the quantum elastic resource gateway includes a quantum error correction module.

In some embodiments, the prioritized routing module determines the optimized gateway route in response to the prioritization value. In some embodiments, the present invention transfers the resource via the recommendations module, wherein the recommendations module determines the optimized gateway route in response to one or more previously recommended optimized gateway routes.

In some embodiments, the optimal resource transfer system may weigh the recommendations module's recommendations with the resource transfer request. In this way, the optimal resource transfer system may compare historical resource transfers (e.g., from the recommendations module) with the current resource transfer (e.g., resource transfer request) to determine the optimized gateway route. In this way, doing so may allow the optimal resource transfer system to determine how well prior gateway routes may transfer the current resource. For instance, and by way of non-limiting example, the optimal resource transfer system may determine that a prior gateway route is well suited to transfer the current resources, given that the resource transfer request has similar characteristics.

In some embodiments, the quantum node optimization algorithm includes the one or more quantum route optimization algorithms, wherein the quantum node optimization algorithm connects the one or more quantum route optimization algorithms.

In some embodiments, the quantum error correction module includes determining, in response to the resource transfer request failing to complete, the resource should be transferred to the submitting device. In some embodiments, the quantum error correction module includes transferring the resource to the submitting device through the one or more gateways.

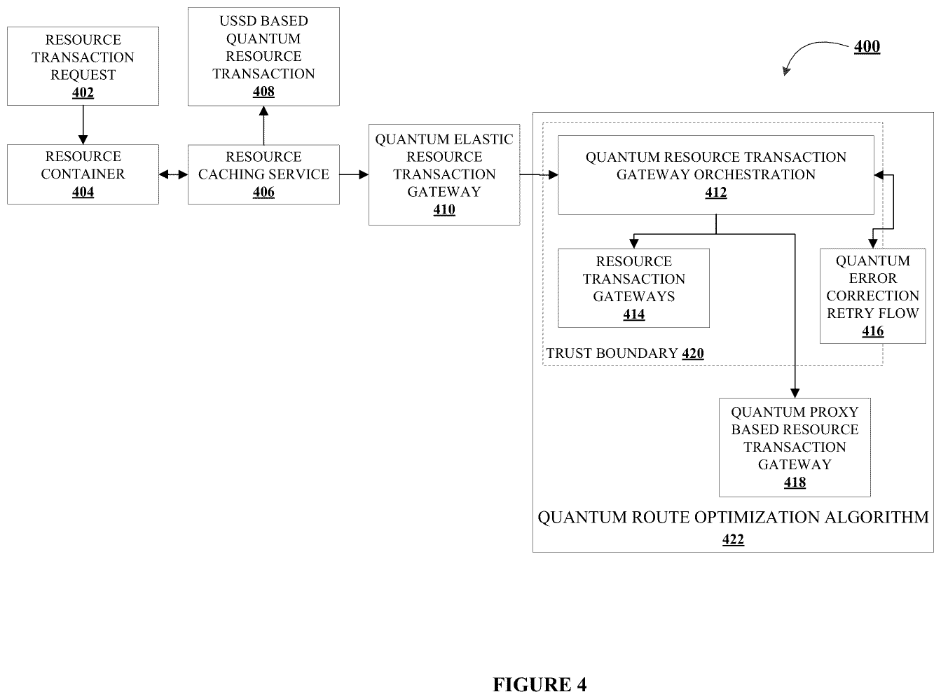

FIG. 4 illustrates a non-limiting example process flow of a quantum route optimization algorithm, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an optimal resource transfer system (e.g., similar to one or more of the systems described herein with respect to FIGS. 1A-1C) may perform one or more of the steps of process flow 400. For example, an optimal resource transfer system (e.g., the system 130 described herein with respect to FIGS. 1A-1C) may perform the steps of process flow 400.

As shown in block 402, the process flow 400 of this embodiment includes a resource transaction request. In some embodiments, the resource transaction request may include a resource transaction request from a user, an entity, an entity associated with a user, a merchant, a merchant associated with a user, a financial institution, a financial institution associated with a user, and/or the like.

As shown in block 404, the process flow 400 of this embodiment includes a resource container. In some embodiments, the resource container may include a debit card, a credit card, a check, a virtual wallet, and/or the like. In some embodiments, the resource container may contain a variety of types of resources.

As shown in block 406, the process flow 400 of this embodiment includes a resource caching service. In some embodiments, the resource caching service may include a resource storage system. In some embodiments, the optimal resource transfer system may receive resources to be transferred from the resource caching service. In some embodiments, the resource caching service may receive the resource transaction request.

As shown in block 408, the process flow 400 of this embodiment includes a USSD (Unstructured Supplementary Service Data) based quantum resource transaction. In some embodiments, the USSD may include a communication protocol used to send messages between devices. In some embodiments, the USSD based quantum resource transaction may allow a user to request a resource transfer from the user's user device.

As shown in block 410, the process flow 400 of this embodiment includes a quantum elastic resource transaction gateway. In some embodiments, the quantum elastic payment gateway may receive the resources from the resource caching service. In some embodiments, the quantum elastic payment gateway may provide scalable, dynamic, secure gateways that implement artificial intelligence and quantum computing.

As shown in block 412, the process flow 400 of this embodiment includes a quantum resource transaction gateway orchestration. In some embodiments, the quantum resource transaction gateway orchestration may include connecting different types of resource institutions or resource transfer programs. For instance, and by way of non-limiting example, this may include orchestrating resource transfers to and/or from a stock market, cryptocurrency payment, payment initiation service provider, account information service provider, business to business, third party payments, payment service directive, business to consumer payment service provider, and/or the like.

As shown in block 414, the process flow 400 of this embodiment includes resource transaction gateways. In some embodiments, the resource transaction gateways may include a stock market, cryptocurrency payment, payment initiation service provider, account information service provider, business to business, third party payments, payment service directive, business to consumer payment service provider, and/or the like.

As shown in block 416, the process flow 400 of this embodiment includes a quantum error correction retry flow. In some embodiments, the quantum error correction retry flow may include a procedure that allows for resources to be transferred back to the submitting device. In this way, the quantum error correction retry flow may include identifying secure resource transfer routes with the least latency for reversal of resource transfers. In some embodiments, the optimal resource transfer system may determine the quantum error correction retry flow in a similar way as it determines the optimized gateway route. In some embodiments, the optimal resource transfer system may determine the quantum error correction retry flow by including the securitization value, expense value, prioritization value, and/or the like of the gateway(s) in the route.

As shown in block 418, the process flow 400 of this embodiment includes a quantum proxy based resource transaction gateway. In some embodiments, the quantum proxy based resource transaction gateway may include transferring a resource to a proxy gateway. In this way, the quantum proxy based payment gateway may include resource transaction gateways (e.g., similar to block 414) that are owned and operated by third parties. For instance, and by way of non-limiting example, a resource may transfer to a quantum proxy based payment gateway, wherein the quantum proxy based payment gateway is hosted by a third party.

As shown in block 420, the process flow 400 of this embodiment includes a trust boundary. In some embodiments, the trust boundary may include a security layer that transfers resources in a secure manner. In some embodiments, the trust boundary may include a gateway vetting process to ensure the gateways are verified gateways. In some embodiments, the trust boundary may extend to third party gateways.

As shown in block 422, the process flow 400 of this embodiment includes a quantum route optimization algorithm. In some embodiments, the quantum route optimization algorithm may include determining an optimized gateway route. In some embodiments, the quantum route optimization algorithm may include determining the least latency among the gateways for the resource transfer. In some embodiments, the quantum route optimization algorithm may include determining gateway characteristics to determine gateways that are the most efficient in transferring the resources. In this way, the optimal resource transfer system may determine consumption of carbon resources in the gateways to determine which gateways use clean energy to transfer resources.

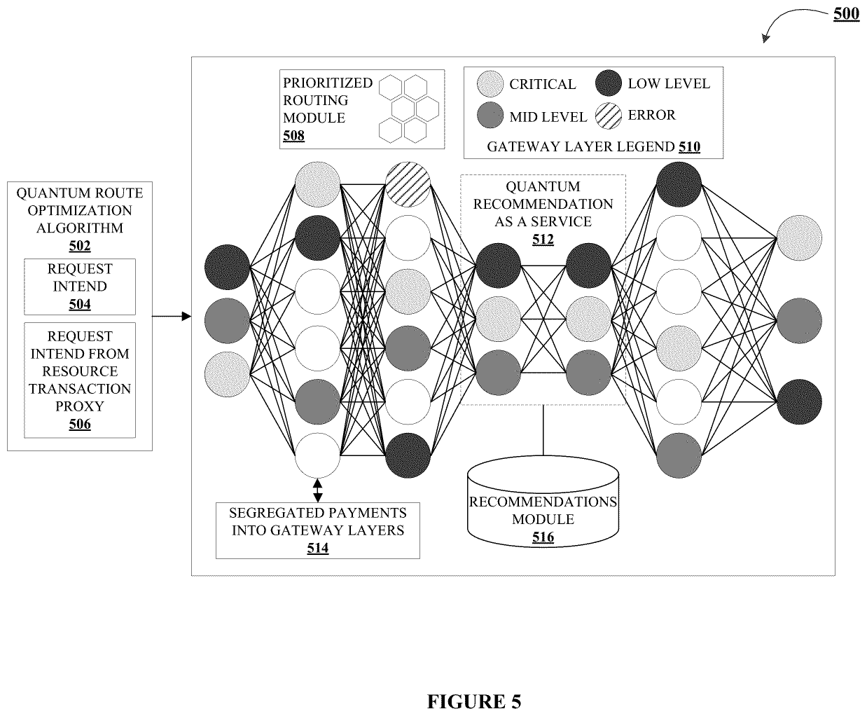

FIG. 5 illustrates a non-limiting example process flow of the optimal resource transfer system, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an optimal resource transfer system (e.g., similar to one or more of the systems described herein with respect to FIGS. 1A-1C) may perform one or more of the steps of process flow 500. For example, an optimal resource transfer system (e.g., the system 130 described herein with respect to FIGS. 1A-1C) may perform the steps of process flow 500.

As shown in block 502, the process flow 500 of this embodiment includes a quantum route optimization algorithm. In some embodiments, the quantum route optimization algorithm may receive a request intend (e.g., request intend 504) or a request intend from resource transaction proxy (e.g., request intend from resource transaction proxy 506). In some embodiments, the quantum route optimization algorithm may transmit the request intend or the request intend from resource transaction proxy to the optimal resource transfer system.

As shown in block 504, the process flow 500 of this embodiment includes a request intend. In some embodiments, the request intend may include a request for a resource transfer from a user. In some embodiments, the request intend may include characteristics from the user, such as priority characteristics, security characteristics, expense characteristics, and/or the like. In this way, the user may be able to tell the optimal resource transfer system the user's desired security level, priority level, expense level, and/or the like.

As shown in block 506, the process flow 500 of this embodiment includes a request intend from resource transaction proxy. In some embodiments, the request intend from resource transaction proxy may include a third party performing a request intend for a user. In this way, the user may give the third party control over an account associated with the user in order for the third party to make resource transaction requests on the user's behalf. In some embodiments, the third party may tell the optimal resource transfer system the desired characteristics of the resource transfer request, which may include security characteristics, priority characteristics, expense characteristics, and/or the like.

As shown in block 508, the process flow 500 of this embodiment includes a prioritized routing module. In some embodiments, the optimal resource transfer system may include a prioritized routing module. In some embodiments, the prioritized routing module may include determining the priority of the resource transfer request (e.g., the priority characteristics of the resource transfer request). In some embodiments, the prioritized routing module may determine the gateways that offer the optimal priority in response to the resource transfer request priority characteristics. In this way, the prioritized routing module may route the resource transfer based on the priority of the gateways in the optimal route.

As shown in block 510, the process flow 500 of this embodiment includes a gateway layer legend. In some embodiments, the gateway layer legend may describe how the gateways in the route may respond to different resource transfer requests. In some embodiments, the gateway layer legend may include the priority characteristics of the ongoing resource transfer requests. In some embodiments, the gateway layer legend may include determining which gateway route may provide the highest priority for a resource transfer in response to the traffic in the optimal resource transfer system. In this way, the gateway layer legend may provide information relating to the resource transfer in comparison with the different available gateways that make up the optimal gateway route.

As shown in block 512, the process flow 500 of this embodiment includes a quantum recommendation as a service. In some embodiments, the optimal resource transfer system may include quantum recommendation as a service. In some embodiments, the quantum recommendation as a service may use quantum computing to determine the optimized gateway route. In some embodiments, the quantum recommendation as a service may include routing the resource transfers in real time in response to the resource transfer request and associated metadata (e.g., security characteristics, priority characteristics, expense characteristics, and/or the like). In some embodiments, the quantum recommendation as a service may include using quantum computing to determine the gateways that will offer the highest priority to a resource transfer. In some embodiments, the quantum recommendation as a service may include using quantum computing to determine the gateways that will offer the most secure gateways. In some embodiments, the quantum recommendation as a service may include using quantum computing to determine the gateways that will offer the lowest expense to a resource transfer.

As shown in block 514, the process flow 500 of this embodiment includes segregated payments into gateway layers. In some embodiments, the segregated payments into gateway layers may include different gateway layers that may make up the optimized gateway route for a resource transfer. In this way, the gateway layers may include gateways that the resource passes through during the optimized gateway route. For instance, and by way of non-limiting example, the gateway layers may include a presentation layer, an application layer, a processing layer, a data layer, a switching layer, a certification layer, a partner API layer, a monitoring layer, a hardware layer, and/or the like. In this way,

As shown in block 516, the process flow 500 of this embodiment includes a recommendations module. In some embodiments, the recommendations module may include determining the optimized gateway route based on the metadata. In some embodiments, the recommendations module may include analyzing the source region, destination region, sender, receiver, amount, timestamp, and/or the like of the resource transfer to determine the optimized gateway route.

In some embodiments, the recommendations module may include storing historical optimized gateway routes. In some embodiments, the recommendations module may include analyzing the historical optimized gateway routes to determine an optimized gateway route for current resource transfers. In some embodiments, analyzing the historical optimized gateway routes may include using gateways that have previously been part of a historical optimized gateway route. In this way, the optimal resource transfer system may use (e.g., re-use) gateways that have previously met requirements of previous resource transfers. In this way, the optimal resource transfer system may continuously learn from optimized gateway routes to determine future optimized gateway routes.

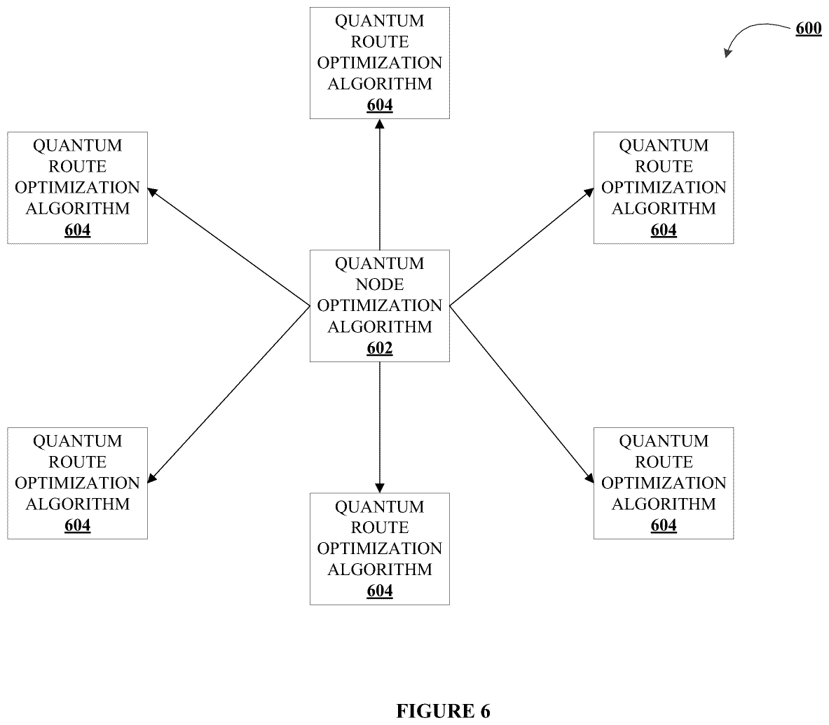

FIG. 6 illustrates a non-limiting example process flow of a quantum node optimization algorithm, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, an optimal resource transfer system (e.g., similar to one or more of the systems described herein with respect to FIGS. 1A-1C) may perform one or more of the steps of process flow 600. For example, an optimal resource transfer system (e.g., the system 130 described herein with respect to FIGS. 1A-1C) may perform the steps of process flow 600.

As shown in block 602, the process flow 600 of this embodiment includes a quantum node optimization algorithm. In some embodiments, the quantum node optimization algorithm may connect one or more quantum route optimization algorithms. In this way, the quantum node optimization algorithm may include transferring resources between the one or more quantum route optimization algorithms. In this way, the quantum node optimization algorithm may determine an optimized gateway route based on optimized gateway routes determined in the one or more quantum route optimization algorithms. In some embodiments, the quantum node optimization algorithm may connect quantum route optimization algorithms in different countries, entities, network environments, and/or the like.

As shown in block 604, the process flow 600 of this embodiment includes a quantum route optimization algorithm. In some embodiments, the quantum route optimization algorithm may include determining an optimized gateway route (e.g., similar to FIG. 5). In some embodiments, the quantum route optimization algorithm may determine optimized gateway routes for intra-gateway resource transfers (e.g., similar to FIG. 4).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining optimal resource transfer routing using quantum gateway optimization, the system comprising:
a processing device;
a non-transitory storage device containing instructions when executed by the processing device, causes the processing device to perform the steps of:
receive a resource transfer request associated with transferring a resource from a submitting device to a receiving device, wherein the resource transfer request comprises resource transfer instructions and resource transfer metadata;
determine, in response to the resource transfer request, an optimized gateway route, wherein the optimized gateway route defines a series of gateways that the resource to be transferred may be processed, and wherein determining the optimized gateway route comprises analyzing the resource transfer instructions, resource transfer metadata, and one or more gateway route characteristics; and
complete the resource transfer request, wherein completing the resource transfer request comprises transferring the resource from the submitting device to the receiving device via the optimized gateway route.

2. The system of claim 1, wherein the resource transfer metadata comprises:
security characteristics, wherein the security characteristics comprise a securitization value associated with the resource transfer request;
priority characteristics, wherein the priority characteristics comprise a prioritization value associated with the resource transfer request; and
expense characteristics, wherein the expense characteristics comprise an expense value associated with the resource transfer request.

3. The system of claim 2, wherein determining the optimized gateway route comprises:
determining, in real time and in response to the resource transfer metadata, the optimized gateway route which provides the highest securitization value;
determining, in real time and in response to the resource transfer metadata, the optimized gateway route which provides the highest prioritization value; and
determining, in real time and in response to the resource transfer metadata, the optimized gateway route which provides the least expense value.

4. The system of claim 1, wherein determining the optimized gateway route comprises:
caching, in response to receiving the resource transfer request, the resource transfer request into a resource caching module; and
processing the resource transfer request in a quantum elastic resource gateway.

5. The system of claim 1, wherein the quantum elastic resource gateway comprises:
a quantum route optimization algorithm, wherein the quantum route optimization algorithm comprises an intra gateway resource transfer request;
a quantum node optimization algorithm, wherein the quantum node optimization algorithm comprises an inter gateway resource transfer request;
a prioritized routing module, wherein the prioritized routing module routes the resource through the one or more gateways based on the resource transfer metadata;
a recommendations module, wherein the recommendations module comprises determining the optimized gateway route based on the resource transfer metadata; and
a quantum error correction module.

6. The system of claim 5, wherein executing the instructions further causes the processing device to:
transfer the resource via the prioritized routing module, wherein the prioritized routing module determines the optimized gateway route in response to the prioritization value; and
transfer the resource via the recommendations module, wherein the recommendations module determines the optimized gateway route in response to one or more previously recommended optimized gateway routes.

7. The system of claim 5, wherein the quantum node optimization algorithm comprises the one or more quantum route optimization algorithms, and wherein the quantum node optimization algorithm connects the one or more quantum route optimization algorithms.

8. The system of claim 5, wherein the quantum error correction module comprises:
determining, in response to the resource transfer request failing to complete, the resource should be transferred to the submitting device; and
transferring the resource to the submitting device through the one or more gateways.

9. The system of claim 1, wherein determining the optimized gateway route comprises:
determining an unoptimized gateway route, wherein the unoptimized gateway route comprises determining the transfer of the resource without optimizing the gateway route;
determining an unoptimized number of resources, wherein the unoptimized number of resources is associated with an unoptimized gateway route;
determining the optimized gateway route;
determining an optimized number of resources, wherein the optimized number of resources is associated with the optimized gateway route; and
ensuring the optimized number of resources is equal to or less than the unoptimized number of resources.

10. The system of claim 1, wherein the gateway route characteristics comprise:
an existing volume, wherein the existing volume is associated with a volume of traffic a network is currently experiencing, wherein the network comprises one or more gateway routes;
an existing latency, wherein the existing latency is associated with a latency the network is currently experiencing;
a gateway security, wherein the gateway security is associated with a gateway security value of the one or more gateways; and
a gateway expense, wherein the gateway expense is associated with a gateway expense value of the one or more gateways.

11. The system of claim 10, wherein determining the optimized gateway route comprises:
ensuring the gateway security value is equal to or greater than the security value associated with the resources transfer request; and
ensuring the gateway expense value is equal to or less than the expense value associated with the resource transfer request.

12. A computer program product for determining optimal resource transfer routing using quantum gateway optimization, the computer program product comprising a non-transitory computer-readable medium comprising code causing an apparatus to:
receive a resource transfer request associated with transferring a resource from a submitting device to a receiving device, wherein the resource transfer request comprises resource transfer instructions and resource transfer metadata;
determine, in response to the resource transfer request, an optimized gateway route, wherein the optimized gateway route defines a series of gateways that the resource to be transferred may be processed, and wherein determining the optimized gateway route comprises analyzing the resource transfer instructions, resource transfer metadata, and one or more gateway route characteristics; and
complete the resource transfer request, wherein completing the resource transfer request comprises transferring the resource from the submitting device to the receiving device via the optimized gateway route.

13. The computer program product of claim 1, wherein the resource transfer metadata comprises:
security characteristics, wherein the security characteristics comprise a securitization value associated with the resource transfer request;
priority characteristics, wherein the priority characteristics comprise a prioritization value associated with the resource transfer request; and
expense characteristics, wherein the expense characteristics comprise an expense value associated with the resource transfer request.

14. The computer program product of claim 2, wherein determining the optimized gateway route comprises:
determining, in real time and in response to the resource transfer metadata, the optimized gateway route which provides the highest securitization value;
determining, in real time and in response to the resource transfer metadata, the optimized gateway route which provides the highest prioritization value; and
determining, in real time and in response to the resource transfer metadata, the optimized gateway route which provides the least expense value.

15. The computer program product of claim 1, wherein determining the optimized gateway route comprises:
caching, in response to receiving the resource transfer request, the resource transfer request into a resource caching module; and
processing the resource transfer request in a quantum elastic resource gateway.

16. The computer program product of claim 1, wherein the quantum elastic resource gateway comprises:
a quantum route optimization algorithm, wherein the quantum route optimization algorithm comprises an intra gateway resource transfer request;
a quantum node optimization algorithm, wherein the quantum node optimization algorithm comprises an inter gateway resource transfer request;
a prioritized routing module, wherein the prioritized routing module routes the resource through the one or more gateways based on the resource transfer metadata;
a recommendations module, wherein the recommendations module comprises determining the optimized gateway route based on the resource transfer metadata; and
a quantum error correction module.

17. A method for determining optimal resource transfer routing using quantum gateway optimization, the method comprising:
receiving a resource transfer request associated with transferring a resource from a submitting device to a receiving device, wherein the resource transfer request comprises resource transfer instructions and resource transfer metadata;
determining, in response to the resource transfer request, an optimized gateway route, wherein the optimized gateway route defines a series of gateways that the resource to be transferred may be processed, and wherein determining the optimized gateway route comprises analyzing the resource transfer instructions, resource transfer metadata, and one or more gateway route characteristics; and
completing the resource transfer request, wherein completing the resource transfer request comprises transferring the resource from the submitting device to the receiving device via the optimized gateway route.

18. The method of claim 17, wherein the resource transfer metadata comprises:
security characteristics, wherein the security characteristics comprise a securitization value associated with the resource transfer request;
priority characteristics, wherein the priority characteristics comprise a prioritization value associated with the resource transfer request; and
expense characteristics, wherein the expense characteristics comprise an expense value associated with the resource transfer request.

19. The method of claim 18, wherein determining the optimized gateway route comprises:
determining, in real time and in response to the resource transfer metadata, the optimized gateway route which provides the highest securitization value;
determining, in real time and in response to the resource transfer metadata, the optimized gateway route which provides the highest prioritization value; and
determining, in real time and in response to the resource transfer metadata, the optimized gateway route which provides the least expense value.

20. The method of claim 17, wherein determining the optimized gateway route comprises:
caching, in response to receiving the resource transfer request, the resource transfer request into a resource caching module; and
processing the resource transfer request in a quantum elastic resource gateway.
